(19) United States
(12) Patent Application Publication
(10) Pub. No.: US 2026/0346737 A1
(43) Pub. Date: Nov. 5, 2026

(54) SOLID-STATE PRE-CHARGE SWITCH FOR HIGH-VOLTAGE ENERGY STORAGE SYSTEMS

(71) Applicant: BAE Systems Controls Inc., Endicott, NY (US)

(72) Inventors: Joshua P. Stewart, Vestal, NY (US); Arthur P. Lyons, Maine, NY (US); Matthew S. Boecke, Endicott, NY (US)

(73) Assignee: BAE Systems Controls Inc., Endicott, NY (US)

(21) Appl. No.: 19/665,686

(22) Filed: May 1, 2026

Related U.S. Application Data
(60) Provisional application No. 63/798,296, filed on May 1, 2025.

(51) Int. Cl. B60L 50/40; B60L 50/60

(52) U.S. Cl. CPC B60L 50/40; B60L 50/60

(57) ABSTRACT

A pre-charge circuit for pre-charging battery currents to loads and method of pre-charging circuit loads. The pre-charge circuit includes a solid-state active switch device that replaces any pre-charge resistor. When pre-charging a load, a first switch is activated to connect a battery to the solid-state active switch. The solid-state active switch is actuated (closed) by a control signal to modify a resistance of the solid-state active switch, for instance, by controlling a channel resistance between a source and drain terminal, thus providing a pre-charge resistance that battery current flows through for charging the load through the solid-state active switch device. A contactor is required to maintain galvanic isolation, but the size of the contactor can be greatly reduced. The overall size and weight of the pre-charge components can be reduced by as much as 80 %.

### CROSS REFERENCE TO RELATED APPLICATION

The present application claims benefit of United States Provisional Application No. 63/798,296 filed on May 1, 2025, all of the contents of which are incorporated herein by reference.

### FIELD OF THE DISCLOSURE

This disclosure relates to power units for vehicles such as battery electric vehicles and hybrid electric vehicles. More particularly, this disclosure relates to a solid-state pre-charge circuit of reduced component weight and a method for pre-charging capacitive-type circuit loads that avoids impacting components receiving high voltage power from batteries and battery packs.

### BACKGROUND

Battery electric vehicles and hybrid electric vehicles have an electric power system to drive a motor and/or other components that require high-voltage electric power supplied from an electric power system including a re-chargeable battery or battery pack.

Before a battery pack can be brought online, a high voltage link must be pre-charged to bring the output voltage in line with the battery voltage within a certain range. If pre-charge is not performed, high inrush currents can impact performance of the batteries and other electronic equipment.

Traditional pre-charge circuits use a pre-charge contactor and a pre-charge resistor. The same is true when there are multiple battery packs in parallel in a high voltage system. Packs at different voltages must initially pre-charge before they can be connected to a common DC link.

FIG. 1 depicts a conventional pre-charge circuit 50 shown connected between a battery, e.g., high energy voltage source 52, and its load such as a motor controller unit 60 in a vehicle. The pre-charge circuit 50 includes one or more physical contactors or switches such as positive contactor 55A connected to a positive (+’ive) terminal of a high voltage battery and negative contactor 55B connecting to a negative (-’ive) terminal of a high voltage battery. The contactors 55A, 55B are activated to complete the circuit and permit flow of current from the high energy voltage source 52 to the motor controller unit load 60. Pre-charge circuit includes a series connection of a switch 70 and a pre-charge resistor 75, the series connection being further connected in parallel to one of the contactors 55. That is, before activating the contactor 55, the pre-charge circuit 50 can activate or close switch 70 such that a reduced current initially flows through pre-charge resistor 75 to the motor controller unit load 60. Once the motor controller unit load 60 is sufficiently pre-charged, the switch 70 is de-activated or opened and the circuit contactors or physical switches 55A, 55B can be activated or closed such that the full operating current flows from the energy source 52 to the motor controller unit load 60.

Depending on the capacitance of the system that must be pre-charged, and a requirement for maximum time to pre-charge, the resistor and contactor can be quite large, driving battery volume and mass. That is, while the existing pre-charge circuit of FIG. 1 use a pre-charge resistor 75 to control the device charging when connected to a battery, this has also been found to be require a large-sized contactor to maintain galvanic isolation between the battery power source and the component or device being charged, e.g., a DC link used to drive a motor.

The problem of weight and volume budgets for pre-charge components is exacerbated when there are multiple battery strings or packs. For example, a system with one pack might have a pre-charge component weight of X and volume of Y. In a system of the same voltage and energy but with more battery strings, the pre-charge circuit will be replicated on all battery packs. For an equivalent system with six (6) battery strings, the pre-charge component weight would be 6*X and volume 6*Y.

### SUMMARY

In an electric or hybrid vehicle, a pre-charge system and a method for pre-charging a capacitive circuit load.

In an electric or hybrid vehicle, a pre-charge system that facilitates use of battery/battery packs and pre-charge components having reduced weight and volume.

In an electric or hybrid vehicle, the pre-charge system includes a solid-state active switch instead of the pre-charge resistor that will allow for weight and volume reduction of the battery/battery packs. In the pre-charge system including a solid-state active switch, while a contactor is still required to maintain galvanic isolation, the size of the contactor can be greatly reduced.

In an embodiment, the pre-charge system includes a solid-state active switch such that the overall size and weight of the pre-charge components can be reduced by as much as 80 % compared to traditional pre-charge circuits in vehicles.

In one aspect, there is provided a system for pre-charging a capacitive circuit load using a battery. The system comprises: a contactor switching device connected in series between the battery and the capacitive circuit load; and a series circuit connection of a first switching device and a second switching device, the series circuit connection connected in parallel across the contactor switching device, the second switching device comprising a solid-state switching transistor controllable by an input control signal.

In an embodiment, the contactor switching device is actuated in an open circuit configuration and each the first switching device and second switching device are closed to provide a pre-charge current flow from the battery to the capacitive circuit load.

Further to this embodiment, the second switching device is configured to receive an input control signal to configure the second switching device into a resistive state sufficient to limit pre-charge current flow from the battery to the capacitive circuit load.

Further to this embodiment, the first switching device and second switching device are opened and the contactor switching device is actuated in a closed circuit configuration to provide a normal operating current flow from the battery to the capacitive circuit load through the contactor switching device.

In a further aspect, there is provided a method of pre-charging a capacitive circuit load using a battery. The method comprises: actuating, into an open circuit configuration, a contactor switching device connected in series between the battery and the capacitive circuit load; actuating, into a closed operating state, a first switching device; and actuating, into a closed operating state, a second switching device, the first switching device and second switching device being connected in-series to provide a pre-charge current flow from the battery to the capacitive circuit load, the in-series connection of the first switching device and second switching device being connected in parallel across the contactor switching device.

In an embodiment, the second switching device comprises a solid-state switching transistor, the actuating said second switching device comprises: receiving, at a terminal of said solid-state switching transistor, an input control signal, said input control signal configuring the second switching device into a resistive state to limit the pre-charge current flow from the battery to the capacitive circuit load.

Further to this aspect, the method further comprises actuating, into a closed circuit configuration, the contactor switching device connected in series between the battery and the capacitive circuit load; actuating, into an open operating state, the first switching device; and actuating, into an open operating state, the second switching device to provide a normal operating current flow from the battery to the capacitive circuit load through the contactor switching device.

Embodiments of the invention will be described in more detail below, by way of illustrative and non-limiting examples, with reference to the accompanying drawings.

### BRIEF DESCRIPTION OF THE DRAWINGS

FIG. 1 depicts a conventional pre-charge circuit connected between a battery and its load such as a motor controller unit in a vehicle;

FIG. 2 depicts a plot of an example load voltage versus time, e.g., at a power up time when a battery or battery pack connects to a high voltage direct current (HVDC) system load and also depicts a corresponding plot of the battery’s pre-charge current versus time;

FIG. 3 depicts a pre-charge circuit in accordance with aspects of the disclosure;

FIG. 4 illustrates an example electronic circuit power distribution system employing a solid-state pre-charge circuit in accordance with an embodiment; and

FIG. 5 depicts exemplary pre-charge circuit components including a depiction of the relative size and weight of common pre-charge circuit components.

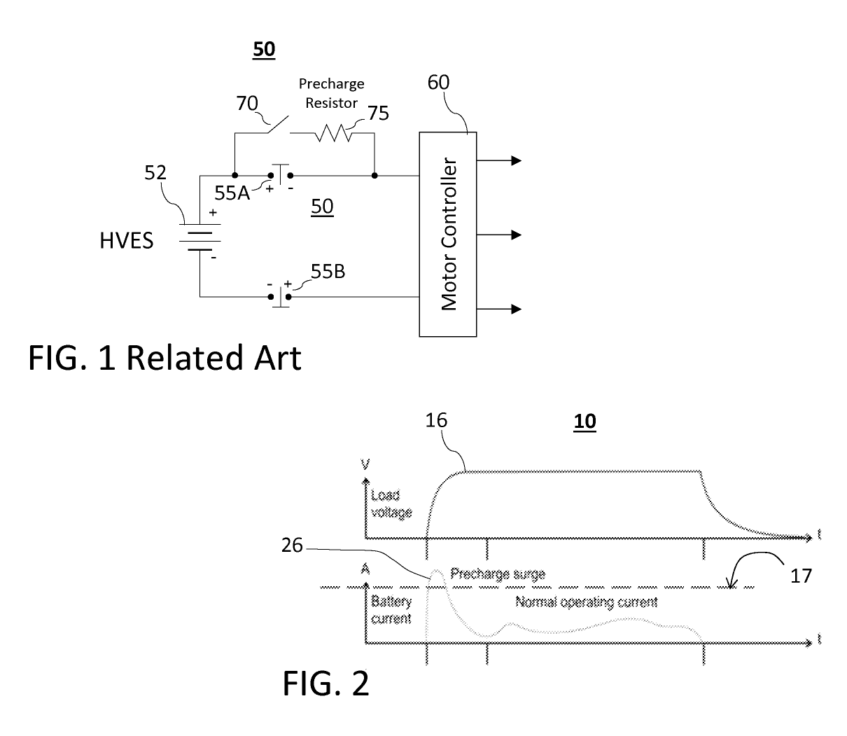

### DETAILED DESCRIPTION

In accordance with aspects of the disclosure, there is provided a pre-charge circuit for use in a hybrid vehicle, e.g., battery vehicle, electric vehicle, fuel cell powered-vehicles, etc., that facilitates use of batteries and battery packs having reduced weight and volume. In embodiments, the pre-charge circuit of the present disclosure is for use in an airplane, helicopter, UAV, or any other powered air vehicles or ground-based vehicles.

FIG. 2 depicts a plot 10 of an example load voltage curve 16 versus time, e.g., at a power up time when a battery or battery pack connects to a high voltage direct current (HVDC) system. FIG. 2 also depicts a corresponding plot of the battery’s pre-charge current 26 versus time. In the corresponding example load voltage curve 16 and plot of the battery’s pre-charge current 26, it is seen that when initially connecting a battery to a load with capacitive input (including motor controllers, etc.), there is an inrush of current 26 as the load capacitance is charged up to the battery voltage. A pre-charge circuit connected between the battery and its load is used to limit the inrush current without limiting the operating current 17.

Before a battery pack can be brought online, any high voltage link must be pre-charged to bring the output voltage in line with the battery voltage within a certain range. If pre-charge is not done, high inrush currents can impact performance of the batteries and other electronic equipment.

Further, the pre-charge circuit connections are required to address any of the following are issues: 1) the load has input capacitors or other parts which will be impacted by the inrush current; 2) a main pack fuse will blow if asked to carry the inrush current; 3) the contactors, if present, will be impacted by the inrush current; 4) the battery cells are not rated for the inrush current.

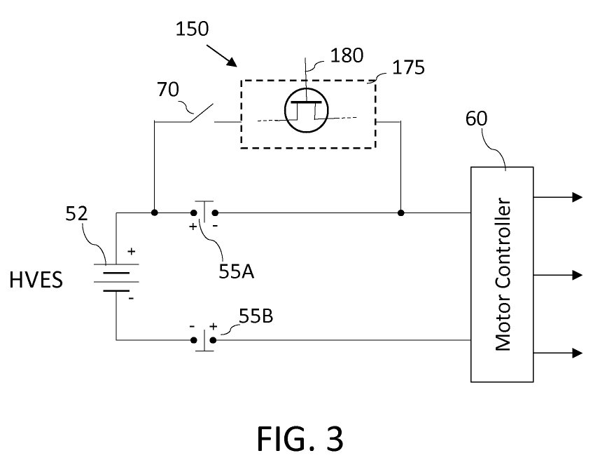

FIG. 3 depicts a pre-charge circuit 150 according to an embodiment of the present invention. When activated, pre-charge circuit 150 limits the inrush current to a load, e.g., motor controller unit 60, without limiting the operating current. In FIG. 3, the pre-charge circuit 150 is connected between a battery, e.g., high energy voltage source 52 and its load such as a motor controller unit 60. It is understood that the capacitive load can comprise any type of capacitive load, including, but not limited to an energy storage element, or a DC link capacitor connected between a rectifier and a voltage source inverter (not shown) of an electric power converter. The pre-charge circuit 150 includes one or more physical contactors or switches such as positive contactor 55A connected to a +’ive terminal of a high voltage battery and negative contactor 55B connecting to a -’ive terminal of a high voltage battery. The contactors 55A, 55B are activated to complete the circuit and permit flow of current from the high energy voltage source 52 to the motor controller unit 60. In an embodiment, the contactors each have a coil input that can be driven by a further control signal or a DC voltage. The coil input may be energized at the same voltage as a motor the contactor is controlling. Pre-charge circuit 150 includes a series connection of a switch 70 and a solid-state active switching transistor device (solid-state active switch) 175, such as a switching transistor. In an embodiment, solid-state active switch 175 can be a transistor such as an Insulated-gate bipolar transistors (IGBT) or a field effect transistor (FET). For example, the FET may be wide bandgap semiconductor such as, but not limited to, silicon carbide (SiC) or gallium nitride (GaN). Each of the contactors and transistor switches are controllable by a processor or like control unit to operate either in opened and closed states in a suitable switching sequence.

As further shown in FIG. 3, the series connection of the switch 70 and a solid-state active switch 175 is connected in parallel across one of the contactors 55A, or 55B. In this embodiment, the pre-charge resistor is eliminated thereby reducing a total weight of the device. Before activating a contactor 55A, 55B, the pre-charge circuit 150 is activated by activating (i.e., closing) switch 70 and additionally activating a control terminal, e.g., transistor gate terminal, by asserting a control signal 180 to control a transistor channel region and modify a resistance of the solid-state active switch 175, e.g., between source and drain terminals, such that a reduced current initially flows through the solid-state active switch 175 to pre-charge the motor controller unit load 60. The control signal 180 can be asserted by a system control unit (not shown) to configure the solid-state active switching device into a resistive state to limit pre-charge current flow from the battery to the capacitive circuit load. Once the motor controller unit load 60 is sufficiently pre-charged, the circuit contactors or physical switches 55A, 55B can be activated or closed such that the full operating current flows from the high energy voltage source 52 to the motor controller unit 60, and once sufficiently pre-charged, then switch 70 and/or solid-state active switch 175 can be de-activated (i.e., opened). This pre-charge circuit 150 addresses and eliminates any potential circuit issues such as: 1) the load having input capacitors or other parts which will be impacted by the inrush current; 2) a main pack fuse will blow if asked to carry the inrush current; 3) the contactors, if present, will be impacted by the inrush current; or 4) the battery cells are not rated for the inrush current.

Functionally, the high-voltage pre-charge circuit 150 is to minimize the peak current out from the power source by slowing down the dV/dt of the input power voltage.

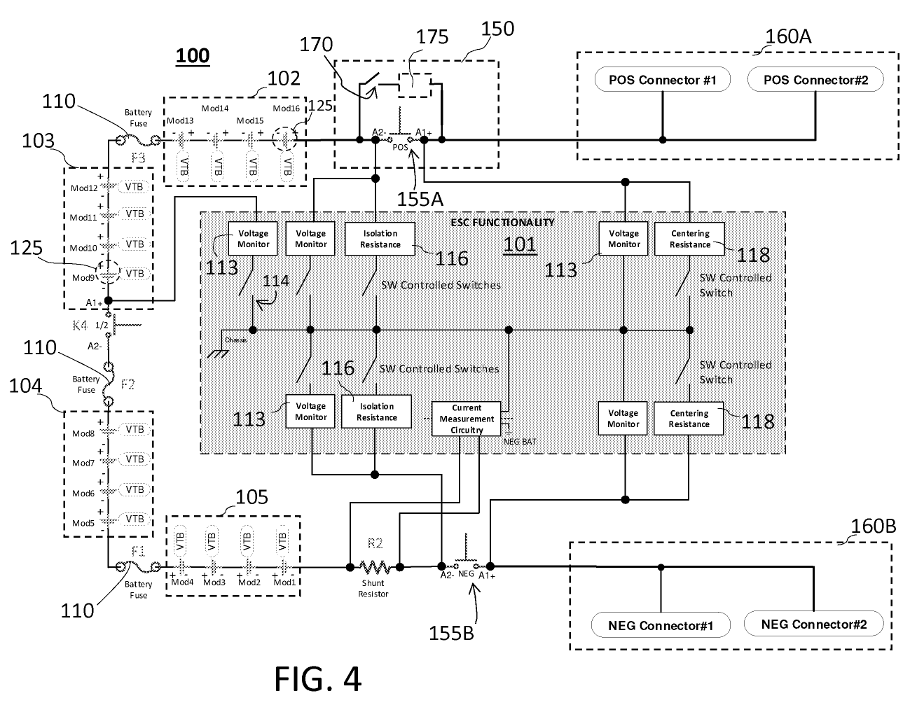

FIG. 4 illustrates an example electronic circuit power distribution system 100 employing a solid-state pre-charge circuit 150 in accordance with an embodiment. In FIG. 4, the pre-charge circuit 150 is connected to a configurable series of one or more battery power sources. For example, four sets of batteries 102, 103, 104, 105 (e.g., each set comprising a configurable series of connected electrochemical cells forming a battery pack) are connected in series with each set separated from each other by a series-connected battery fuse 110. Each set of batteries 102, 103, 104, 105 includes one or more series connected high-voltage battery 125. In FIG. 4, the one or more sets of batteries are used to power a circuit configuration 101 directed to providing electronic stability control (ESC) functionality when powering up a vehicle. In the ESC circuitry 101, there are connected one or more loads 160A that connect to a positive terminal of a set of batteries 102 through contactor or switch 155A and one or more loads 160B that connect to a negative terminal of a battery set 105 through contactor or switch 155B. The ESC circuit 101 include several voltage monitor circuit detectors 113 connected to switches 114 that can be switched in to monitor various voltage levels at respective one or more battery sets and monitor voltage levels before and after the contactor or switch 155A at the solid-state pre-charge circuit 150. Further included in ESC circuit 101 are switchable connections to isolation resistance circuit block 116, and connections to a switched centering resistance circuit block 118.

In an embodiment, in FIG. 4, the pre-charge circuit 150 (of FIG. 3) is connected in series between the last battery 125 of the battery set 102 and a conductor connecting to the load 160A. The pre-charge circuit 150 includes a series connection of a first switch 170 and the solid-state active switch 175, the series circuit connection of a first switch 170 and solid-state active switch 175 is further connected in parallel across one of the contactors, e.g., contactor or switch 155A. In an embodiment, before activating the contactor or switch 155A, the pre-charge circuit 150 is controlled to activate or close switch 170 and assert a control signal to control a transistor channel region of the solid-state active switch 175 in order to modify its resistance, e.g., between source and drain terminals, so that a reduced pre-charge current initially flows through the solid-state active switch 175 to the load 160A. In operation, upon vehicle start-up, the solid-state active switch 175 is controlled to provide a pre-charge resistance that battery current flows through for pre-charging the load through the solid-state active switch device. Once the load 160A, 160B is/are sufficiently pre-charged, the circuit contactors or switches 155A, 155B can be activated or closed such that the full operating current can directly flow from the set(s) of energy sources or batteries 102, . . . , 104 to the connected loads 160A, 160B. Then the switch 170 and solid-state active switch 175 can then be de-activated or opened.

Thus, in accordance with the described embodiment, the solid-state active switch 175 replaces the pre-charge resistor. The contactor is still required to maintain galvanic isolation, but the size of the contactor can be greatly reduced. The overall size and weight of the pre-charge components can be reduced by as much as 80 %.

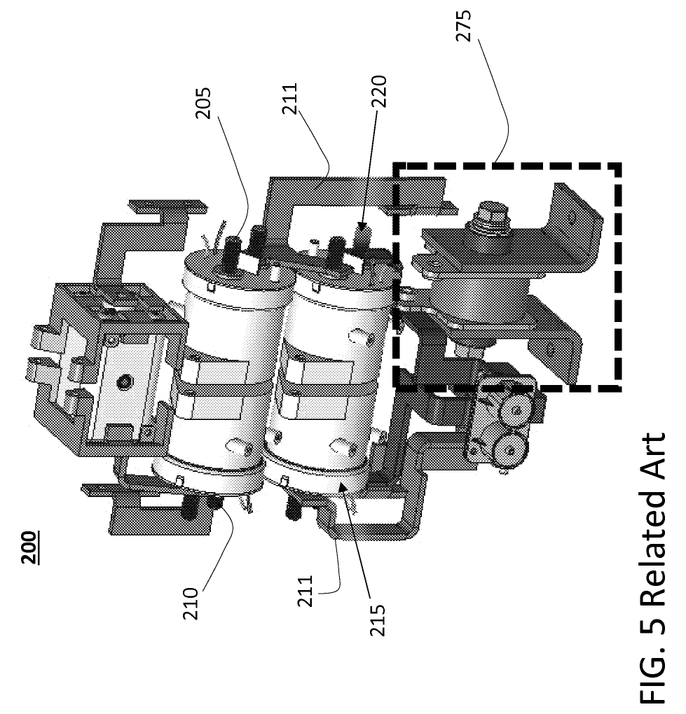

FIG. 5 depicts an exemplary unit 200 consisting of pre-charge circuit components including a depiction of the relative size and weight of common pre-charge circuit components, including but not limited to: a pre-charge contactor 205, a mid-pack contactor 210, a negative contactor 215, and a positive contactor 220. The contactors can be part of an EV200 Series contactor (e.g., rated at 500 A) at operating voltages of 12-900 VDC. The contactor unit can weigh about 0.43 kg while connective wires/busbars 211 can weight about 0.05 kg. The present embodiment of the invention obviates the need for the pre-charge resistor 275 and thus the unit 200 can eliminate a weight of about 0.347 kg, albeit replacing the pre-charge resistor with the solid-state active switch of much less weight.

In operations, although not shown, the vehicle can include a system control unit (SCU) having, for example, a processor, memory and a communication interface. In an aspect, the processor may be a microcontroller or microprocessor or any other processing hardware such as a CPU or GPU. Memory may be separate from the processor (as or integrated in the same). For example, the microcontroller or microprocessor includes at least one data storage device, such as, but not limited to, RAM, ROM and persistent storage. In an aspect of the disclosure, the processor may be configured to execute one or more programs stored in a computer readable storage device. The computer readable storage device can be RAM, persistent storage, removable storage, or other non-transient computer readable mediums. A storage device is any piece of hardware that is capable of storing information, such as, for example without limitation, data, programs, instructions, program code, and/or other suitable information, either on a temporary basis and/or a permanent basis, for use in operating pre-charge circuit 100.

The SCU can communicate with other vehicle components for determining a vehicle start-up or initializing state and in response, asserts the necessary control signals, e.g., signals for controlling switches 170, 175 of the pre-charge circuit. module 11 that controls the solid-state active switching devices.

As described herein, aspects of the present disclosure may include one or more electrical, pneumatic, hydraulic, or other similar secondary components and/or systems therein.

The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive aspects described herein. It is, therefore, to be understood that the foregoing aspects are presented by way of example only and that, within the scope of the appended claims and equivalents thereto, inventive aspects may be practiced otherwise than as specifically described and claimed. Inventive aspects of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described aspects of the disclosure can be implemented in any of numerous ways. For example, aspects of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, a single FPGA may be used, or multiple FPGAs may be used to achieve the functions, features or instructions described herein.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1 % of the stated value (or range of values), +/−1 % of the stated value (or range of values), +/−2 % of the stated value (or range of values), +/−5 % of the stated value (or range of values), +/−10 % of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result. Additionally, the features may be performed at the same time.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various aspects of the disclosure are examples and the disclosure is not limited to the exact details shown or described. The terminology used herein is for the purpose of describing particular aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A system for pre-charging a capacitive circuit load using a battery, the system comprising:
a contactor switching device connected in series between the battery and the capacitive circuit load; and
a series circuit connection of a first switching device and a second switching device, the series circuit connection connected in parallel across said contactor switching device, the second switching device comprising a solid-state switching transistor controllable by an input control signal.

2. The system as claimed in claim 1, wherein, the contactor switching device is actuated in an open circuit configuration and said first switching device and said second switching device are conductive to provide a pre-charge current flow from said battery to said capacitive circuit load.

3. The system as claimed in claim 2, wherein said second switching device is operable to receive the input control signal to configure the second switching device into a resistive state to limit pre-charge current flow from the battery to the capacitive circuit load.

4. The system as claimed in claim 1, wherein, the first switching device and the second switching device are opened and the contactor switching device is actuated in a closed circuit configuration to provide an operating current flow from said battery to said capacitive circuit load through said contactor switching device.

5. The system as claimed in claim 1, wherein said second switching device is a solid-state active switching transistor.

6. The system as claimed in claim 5, wherein said solid-state active switching transistor is a field-effect transistor device (FET).

7. The system as claimed in claim 5, wherein said solid-state active switching transistor is an insulated-gate bipolar transistor device (IGBT).

8. The system as claimed in claim 1, wherein said capacitive circuit load is a direct current (DC) link.

9. A method of pre-charging a capacitive circuit load using a battery, the method comprising:
actuating, into an open circuit configuration, a contactor switching device connected in series between the battery and the capacitive circuit load;
actuating, into a closed operating state, a first switching device; and
actuating, into a closed operating state, a second switching device, the first switching device and the second switching device being connected in-series to provide a pre-charge current flow from said battery to said capacitive circuit load, the in-series connection of said first switching device and second switching device being connected in parallel across said contactor switching device.

10. The method as claimed in claim 9, wherein the second switching device comprises a solid-state active switching transistor, the actuating said second switching device comprises:
receiving, at a terminal of said solid-state active switching transistor, an input control signal, said input control signal configuring the second switching device into a resistive state to limit the pre-charge current flow from the battery to the capacitive circuit load.

11. The method as claimed in claim 10, wherein said solid-state active switching transistor is a field-effect transistor device (FET).

12. The method as claimed in claim 10, wherein said solid-state active switching transistor is an insulated-gate bipolar transistor device (IGBT).

13. The method as claimed in claim 9, further comprising:
actuating, into a closed circuit configuration, the contactor switching device connected in series between the battery and the capacitive circuit load;
actuating, into an open operating state, the first switching device; and
actuating, into an open operating state, the second switching device to provide an operating current flow from said battery to said capacitive circuit load through said contactor switching device.
